(19) United States
(12) Patent Application Publication
(10) Pub. No.: US 2015/0251026 A1
(43) Pub. Date: Sep. 10, 2015

(54) Method for prolonging the duration of use of a self-contained compressed air breathing apparatus

(71) Applicant: Andreas Gradischar, Wien (AT)

(72) Inventor: Andreas Gradischar, Wien (AT)

(21) Appl. No.: 14/433,899

(22) PCT Filed: Oct. 9, 2013
(86) PCT No.: PCT/AT2013/000166

§ 371 Date: Apr. 7, 2015

(30) Foreign Application Priority Data
Oct. 9, 2012 (AT) A 1090/2012

(51) Int. Cl. A62B 7/02; A62B 23/02; A62B 7/10; A62B 9/02; A62B 9/06

(52) U.S. Cl. CPC A62B 7/02; A62B 9/02; A62B 9/06; A62B 7/10; A62B 23/02

(57) ABSTRACT

In a method and a device for prolonging the duration of use of a self-contained compressed air breathing apparatus, which includes a storage tank for a pressurised gas mixture containing oxygen, a breathing regulator connected to the storage tank, wherein a pressure regulator can optionally be inserted therebetween, and a mouthpiece, the following steps are provided:
a) inhalation of the gas mixture from the storage tank,
b) exhalation of the gas mixture into a breathing gas reservoir,
c) inhalation of the gas mixture from the breathing gas reservoir and
d1) exhalation of the gas mixture into the breathing gas reservoir or
d2) exhalation of the gas mixture into the surroundings.

The invention relates to a method for prolonging the duration of use of a self-contained compressed air breathing apparatus, which comprises a storage tank for a pressurised gas mixture containing oxygen, a breathing regulator connected to the storage tank, wherein a pressure reducer can optionally be inserted therebetween, and a mouthpiece.

The invention also relates to a device for prolonging the duration of use of self-contained compressed air breathing apparatuses, comprising a valve device and a breathing gas reservoir, wherein the valve device comprises at least one exhalation/inhalation connection to be connected to the mouthpiece, a respiratory regulator connection and an exhalation opening and is connected via at least one connection line to the breathing gas reservoir.

Self-contained compressed air breathing apparatuses are used, among other things, in scuba diving or for respiratory protection applications. If the ambient air contains too little oxygen (less than 17% by volume), or if toxic gases are present which cannot be absorbed by gas or combination filters, and if the type and/or concentration of the toxic gases is unknown, self-contained respiratory protection must be used. As during operations, for example in the case of the fire service, it is difficult to determine whether sufficient air is actually present in the ambient air, self-contained breathing apparatuses are mainly used. When working with self-contained heavy respiratory protection the oxygen necessary for breathing is carried along in a compressed air cylinder.

In scuba diving too, the oxygen required for breathing is carried along in a compressed air cylinder. Because of the increase in the ambient pressure (water pressure) on the rib cage with increasing diving depth, the air pressure of the air breathed in (inhalation air) must increase to the same degree in order to balance out the pressure difference between extracorporeal and intracorporeal area and thereby allow breathing. For each 10 metres of diving depth the ambient pressure and thereby the inhalation pressure provided by the SCUBA (Self-Contained Underwater Breathing Aparatus) apparatus increases by 1 bar.

In SCBA apparatus (SCBA=Self-Contained Breathing Apparatus) a distinction is made in principle between two systems, open systems and circulation systems (rebreather systems). The present invention is concerned with open systems.

An open system is not operated with pure oxygen, but with purified compressed air or air-like gas mixtures (Nitrox, Heliox). As only around 4% of the oxygen is used in one breath, the remaining 17% of the oxygen is lost without being used as the breathed out air is released into the surroundings. Due to their ease of use and comparatively low acquisition costs, open systems are preferred by sports divers and the fire service.

In respiratory protection use self-contained isolating devices, e.g. compressed air breathing apparatuses are used. However due to the limited quantity of air, their use is normally limited to 15-30 minutes. The duration of use depends on the age of the apparatus user, his/her physical fitness and the nature of the load imposed during use. In 200 bar apparatus two cylinders each containing 4 litres are usual. Arithmetically this results in 1600 litres of normal air and a duration of use of approximately half an hour.

Closed circuit rebreather systems are characterised in that after breathing out, the breathing gas is not released into the surroundings, but in the so-called counterlung it is stripped by means of soda lime of the carbon dioxide produced in the body by the metabolism and breathed out via the lungs, and is then breathed in again. The oxygen content in the breathing gas is kept constant in that used oxygen is mechanically, electronically or manually replaced by pure oxygen.

Semi-closed circuit systems are characterised in that the consumed oxygen is replaced using a (mixed) gas source. Through the constant or consumption-dependent addition of breathing gas into the circuit it becomes necessary to release the excess breathing gas into the surroundings by way of a suitable valve.

The great advantage of rebreathers compared with the open circuit systems is the much more efficient use of the used breathing gas and the thereby ensuing prolongation of the duration of use.

Problems with rebreathers result from the costly and complex control technology which is often susceptible to faults and requires special training of the user. Incorrect use or apparatus faults (e.g. used up or damp soda lime) can lead to an increased carbon dioxide content and therefore accidents, such as carbon dioxide poisoning for example.

To prolong the duration of use of open circuit systems DE 102005023392 B2 has already proposed breathing out the inhaled air into a breathing gas reservoir and then breathing this air back in again. The background to rebreathing in open systems is then explained by way of diving applications and respiratory protection applications.

As in diving the composition of the air does not change with increasing ambient pressure, the fractional concentrations of nitrogen (F_{N2}=0.791), oxygen (F_{O2}=0.209), carbon dioxide (F_{cO2}=0.0003) as well as of the other gases (noble gases, trace gases) remain constant. Consequently, at a depth of, for example 10 metres, due to the doubling of the pressure double the amount of oxygen is breathed in: 1 litre at atmospheric pressure contains approximately 130 mg O₂, at double the pressure (at a depth of 10 m in water) the same litre of air already contains 260 mg O₂. However, at higher pressure the human body does not use more oxygen during the same level of activity as on land (air pressure 1 bar). With an O₂ uptake of approximately 30 mg per breath at rest, at 1 bar this corresponds to an O₂ volume of approximately 24 ml, at a pressure of 2 bars this is a volume of approximately 12 ml per breath. This results in an O₂ content (fractional concentration) of the exhaled air of approximately 19% by volume (F_{O2}=0.19). Specifically, the O₂ content of the exhaled air changes via the diving depth, from 16.6% by volume at the water surface to 20.5% by volume at a depth of 30 metres. In any event this O₂ content is sufficient to be able to inhale the exhaled air one more time.

Much more critical than a sufficient oxygen quantity is the increase in the CO₂ concentration. At an atmospheric pressure of 1 bar the exhaled air has a CO₂ content of slightly above 4% by volume, at 10 metres diving depth only approximately 2% by volume. If the exhaled air is inhaled again, this inhaled air already has this increased CO₂ content, and the corresponding exhaled air an even higher content.

The maximum allowable concentration (MAC) at the workplace for 8 hours daily work is 0.5% by volume for CO₂ with an excess factor of 2, i.e. 1% by volume in the case of short-term exposure. However, the toxicity of CO₂ with the onset of symptoms only begins as of 8% by volume. Thus for leisure divers, for whom the MAC value is irrelevant, a mean CO₂ concentration of max. 2% by volume can be used, which leads to a doubling of the diving duration.

The principle of rebreathing can also be used in respiratory protection applications. The exhaled air contains 17% by volume oxygen, which is sufficient for it to be inhaled once more. From the combination of a “fresh air inhalation” and a “recycling inhalation” a mean oxygen content of 19% by volume results which causes no functional impairment.

In the embodiment in accordance with DE 102005023392 B2 the apparatus is switched back and forth between a first setting in which air inhaled from the storage is exhaled into a breathing gas reservoir, and a second setting in which the air in the breathing gas reservoir is rebreathed. Switching over is controlled in a volume dependent manner, i.e. the apparatus switches from the first to the second setting as soon as a defined volume has been exhaled into the breathing gas reservoir. This means that during a majority of breaths air is first of all inhaled from the storage container and then exhaled into the breathing gas reservoir, and then during a majority of breaths air is inhaled from the breathing gas reservoir and exhaled into the surroundings. However, this is associated with a series of disadvantages. On the one hand the rebreathing ratio cannot be changed, i.e. the air can only be rebreathed once from the breathing gas reservoir. On the other hand there is the risk of CO₂ poisoning if the gas in the breathing gas reservoir expands during surfacing so that rebreathing takes place over a longer period than envisaged. In addition, the embodiment in accordance with DE 102005023392 B2 results in a situation that on exhalation of the air into the breathing gas reservoir over a number of breathing cycles a relatively large gas volume accumulated in the breathing gas reservoir which results in an increase in the buoyancy of the diver. In contrast, during rebreathing, the volume in the breathing gas reservoir decreases, so that the diver is subjected to a constant change in level.

The object of the present invention is to further prolong the duration of use of self-contained compressed air breathing apparatuses and avoid the drawbacks, described above.

In order to achieve this object, in accordance with a first aspect the invention provides a method in which a compressed air breathing apparatus with a storage tank for a pressurised gas mixture containing oxygen, a breathing regulator connected to the storage take, optionally with a pressure regulator therebetween and a mouth piece, the following steps are performed directly one after the other:

a) inhalation of the gas mixture from the storage tank,

b) exhalation of the gas mixture into a breathing gas reservoir,

c) inhalation of the gas mixture from the breathing gas reservoir and

d1) exhalation of the gas mixture into the breathing gas reservoir or

d2) exhalation of the gas mixture into the surroundings.

It is therefore essential that only the air of a single breath is always exhaled into the breathing gas reservoir and subsequently rebreathed from the breathing gas reservoir. This method allows every breath to be rebreathed at a precisely defined ratio, whereby this ratio can be 1:1 (i.e. each breath is rebreathed once), 2:1 (each breath is rebreathed twice) or every whole-number multiple thereof (3:1, 4:1 . . . ).

As exhalation takes place either into a breathing gas reservoir or into the surroundings, the drawbacks of complex closed circuit systems are avoided. More particularly, the exhaled air is not mixed with fresh gas mixture so that a defined quantity of oxygen is always available.

In the case of a preferably provided single rebreathing of each breath, one breathing cycle takes place in accordance with step a) and b) and one breathing cycle in accordance with step c) and d2) alternately.

For more than one single rebreathing of each breath it is preferably provided, that after one breathing cycle in accordance with step a) and b), at least one breathing cycle takes place in accordance with step c) and d1) and then finally one breathing cycle in accordance with step c) and d2) takes place. The breathing air of one breath of fresh air is first exhaled into the breathing gas reservoir, whereupon this air is rebreathed from the breathing gas reservoir and exhaled back into the breathing gas reservoir and then rebreathed again. Finally the rebreathed air is exhaled into the surroundings, after which the entire process begins again with the inhalation of one breath of fresh air from the storage tank.

Preferably a ratio of the breathing cycle in accordance with step a) and b) to the number of breathing cycles in accordance with step c) and d1) of 1:2, 1:3 or 1:4 is selected.

Preferably, said mentioned ratio, i.e. the number of consecutive breathing cycles in accordance with step c) and d1) is selected in dependence on at least one environmental factor, more particularly the ambient pressure. The higher the ambient pressure the more often the air can be rebreathed from the breathing gas reservoir without risking falling below the allowable O₂ content or exceeding the allowable CO₂ content.

In addition it is preferably provided that on exhalation the mouthpiece is, with the aid of a switch-over device, optionally connected either to the breathing gas reservoir or the surroundings, whereby the switch-over device is operated by an exhaled or inhaled air flow. The switch-over device can be operated, for example, by a breathing gas flow, a dynamic pressure produced by the breathing gas flow, a differential pressure or a negative pressure.

Because of the possibility of repeated rebreathing, the oxygen contained in the gas mixture is optimally used and the duration of use can be considerably prolonged.

To achieve the aforementioned objective, in accordance with a second aspect the invention provides an arrangement comprising a valve device and a breathing gas reservoir, wherein the valve device has at least one exhalation or inhalation connection for connecting to a mouthpiece, a breathing regulator connection and an exhalation opening and is connected via at least one connection line with the breathing gas reservoir and is characterised in that the valve device interacts with a switch-over device in order to switch the valve, in a breath dependent manner between a first position and second position, wherein in the first stage the exhalation/inhalation connection is connected to the breathing regulator connection for inhalation, and with the breathing gas reservoir for exhalation, and in the second position the exhalation/inhalation connection is connected to the breathing gas reservoir for inhalation and with the exhalation opening for exhalation. With such an arrangement the method in accordance with the invention can be easily implemented. Instead of the mouthpiece, the valve device in accordance with the invention can be effortlessly connected to the breathing regulator of existing compressed-air breathing apparatuses, so that existing systems can be simply upgraded.

The breathing gas reservoir in accordance with the invention preferably involves a flexible bag, which in the empty state is fully collapsed and is inflated through filling with exhaled air. More particularly, the bag is provided with a protective mantle made of a wear-resistant, water and air-impermeable material.

Although the valve device can only be connected via one connection line to the breathing gas reservoir, it is advantageous if the air flows via separate connection lines on inhalation and exhalation. In connection with this the embodiment is such that the valve device is connected via a first connection line and via a second connection line in parallel thereto with the breathing gas reservoir, wherein in a first position the exhalation/inhalation connection is connected to the breathing regulator connection for inhalation and via the first connection line with the breathing gas reservoir for exhalation, and in the second position the exhalation/inhalation connection is connected via the second connection line to the breathing gas reservoir for inhalation and with the exhalation opening for exhalation. The provision of two separate connection lines for the inhalation and exhalation process allows a preferred embodiment, in which in the first connection line a soda lime filter is arranged. In this way carbon dioxide produced on exhalation can be chemically removed before rebreathing.

It is also advantageous if a safety valve is connected to the first connection line.

The exhalation/inhalation connection can be designed as one single connection or a separate inhalation connection and a separate exhalation connection can be provided.

Preferably the device is further developed in such a way that the switch-over device is designed in order to keep the valve device in the first position during precisely one breath, switch over after the breath to the second position and keep it in the second position for at least one further breath.

For the single rebreathing of each breath, the switch-over device is preferably designed in order to switch over the valve device on each breath, so that the valve device diverts every second exhalation into the breathing gas reservoir and takes the air for every second inhalation therefrom.

To achieve multiple rebreathing of a breath, the switch-over device is preferably designed to switch-over the valve device at a breathing ratio of 1:2, 1:3 and/or 1:4. More particular, it is advantageous if the breathing ratio can be adjusted. In doing so the breathing ratio can be manually or automatically adjusted. In the latter case a sensor is provided for an environmental parameter that interacts with the switch-over device in such a way that the breathing ratio is set as a function of the environmental parameter.

In order to ensure reliable and automatic switching over of the valve device it is preferably provided that the switch-over device has a switching element operated by an exhalation or inhalation air flow. For example, the switching element can be operated by a valve flap, on which an exhalation flow acts and which is adjusted thereby and interacts positively or non-positively with the switching element.

Operation of the switch-over device by way of an exhalation or inhalation air flow allows precise, breath-dependent switching over, irrespective of whether this breath is very deep or very shallow.

Here, the switching element can be designed in order, for example, to be operated by a breathing gas flow, dynamic pressure, differential pressure or negative pressure brought about by a breathing gas flow.

In general, switching between the first and the second position and back can take place in any manner, for example, mechanically, electromechanically, electrically, pneumatically or hydraulically or any combination thereof.

In a structurally particularly simple way, the valve device can comprise a rotary piston arranged in a rotational manner in a housing. Preferably the switch-over device interacts with the rotary piston so that on switching from the first into the second position the rotary piston is turned about an angle of 90°. More particularly it can be provided that the rotary piston has a through-hole in order to connect the inhalation/exhalation connection in the first position via the first connection line to the breathing gas reservoir and in the second position via the second connection line to the breathing gas reservoir.

As has already been mentioned, the device in accordance with the invention for further prolonging the duration of diving can be designed so that the rebreathing rate increases as a function of diving depth. Thus between 0 m and 10 m no rebreathing could take place, between 10 m and 20 m every breath is rebreathed once (1:1), between 20 m and 30 m twice (2:1) etc. If a soda lime filter is also used, single rebreathing can already be started between 0 m and 10 m, with the cascade being shifted to lower depths. These relationships are shows in the following table.

| | Rebreathing ratio | Rebreathing ratio |
|---|---|---|
| Depth range | without soda lime filter | with soda lime filter |
| 0 m to 10 m | — | 1:1 |
| 10 m to 20 m | 1:1 | 2:1 |
| 20 m to 30 m | 2:1 | 3:1 |
| 30 m to 40 m | 3:1 | 4:1 |

With an additional design element in the breathing gas reservoir the recycling portion in the range between 0 m and 10 m can be reduced to a safe extent or rebreathing can be discontinued. The reduction can take place, for example, as a function of the diving depth, whereby a closed balloon is integrated into the breathing gas reservoir. At the water surface the volume of the balloon partially or fully fills the volume of the breathing gas container. With increasing external pressure (=diving depth) the volume of the balloon decreases, whereby the useable volume of the breathing gas reservoir increases, as does the degree of rebreathing.

In accordance with a further aspect of the invention a self-contained compressed air breathing apparatus is provided which comprises a storage tank for a pressurised gas mixture containing oxygen, a breathing regulator connected to the storage tank, wherein a pressure regulator can optionally be inserted therebetween, and a mouthpiece, wherein additionally an apparatus in accordance with the invention as described above according to any one of claims 6 to 18 is provided, wherein the exhalation/inhalation connection is connected with the mouthpiece and the breathing regulator connection is connected with the breathing regulator. The breathing regulator and the rebreather according to any one of claims 6 to 18 can be either made of separate components or combined into a single unit.

The invention will be explained in more detail below with the aid of examples of embodiment shown schematically in the drawing.

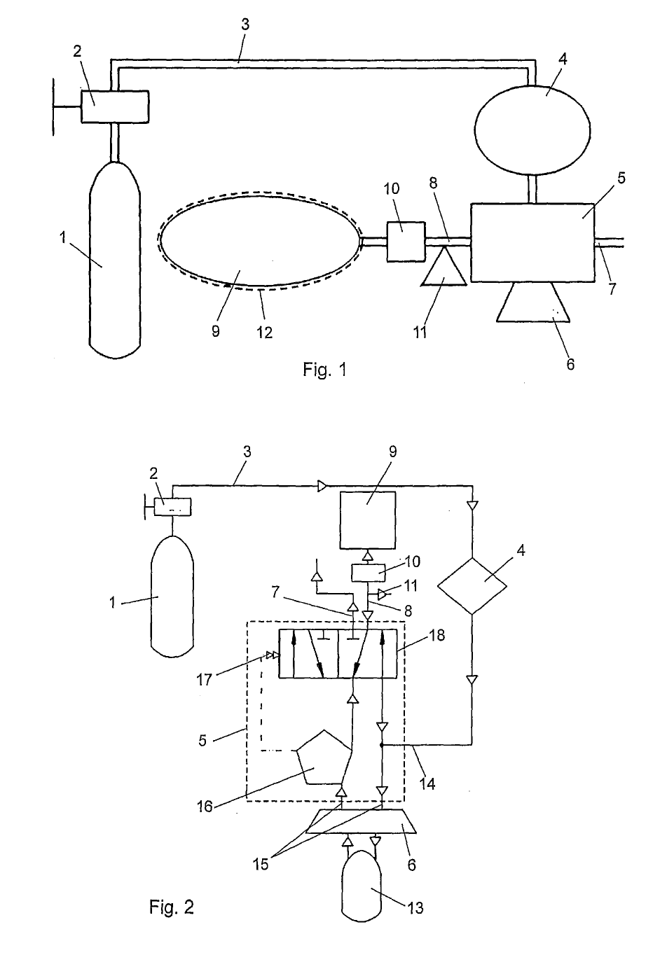

In these FIG. 1 shows a diagram of the principle of the compressed air breathing apparatus in accordance with the invention,

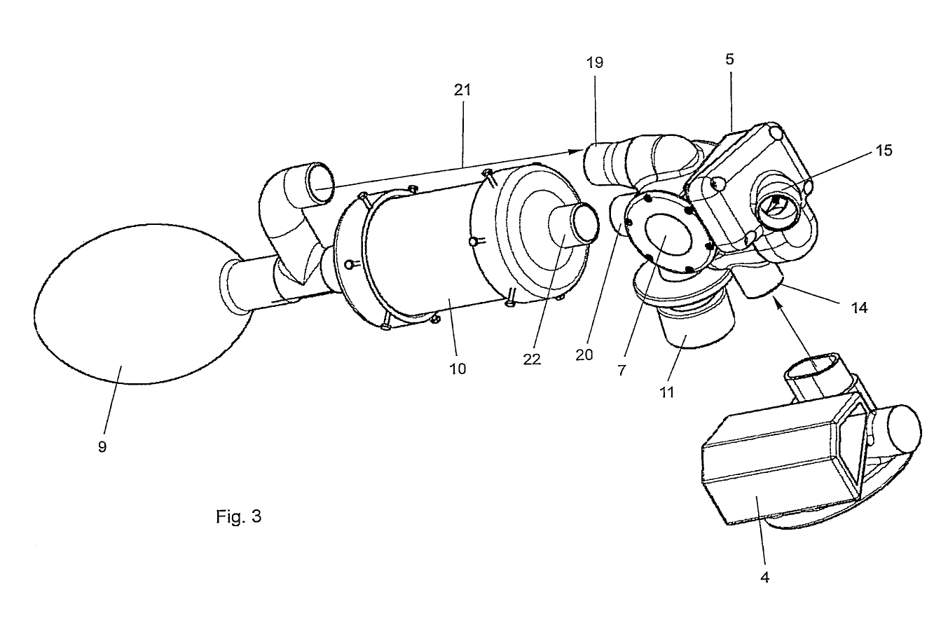

FIG. 2 shows a functional plan of the breathing apparatus,

FIG. 3 shows a three-dimensional view of the valve device and breathing gas reservoir,

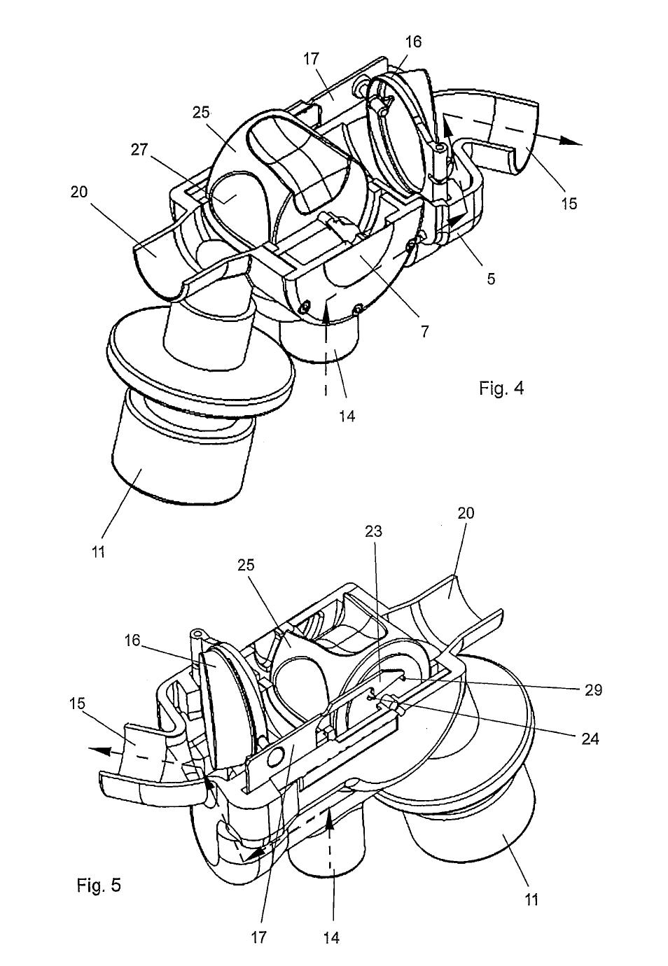

FIG. 4 shows a first view of the valve device during inhalation,

FIG. 5 shows a second view of the valve device during inhalation,

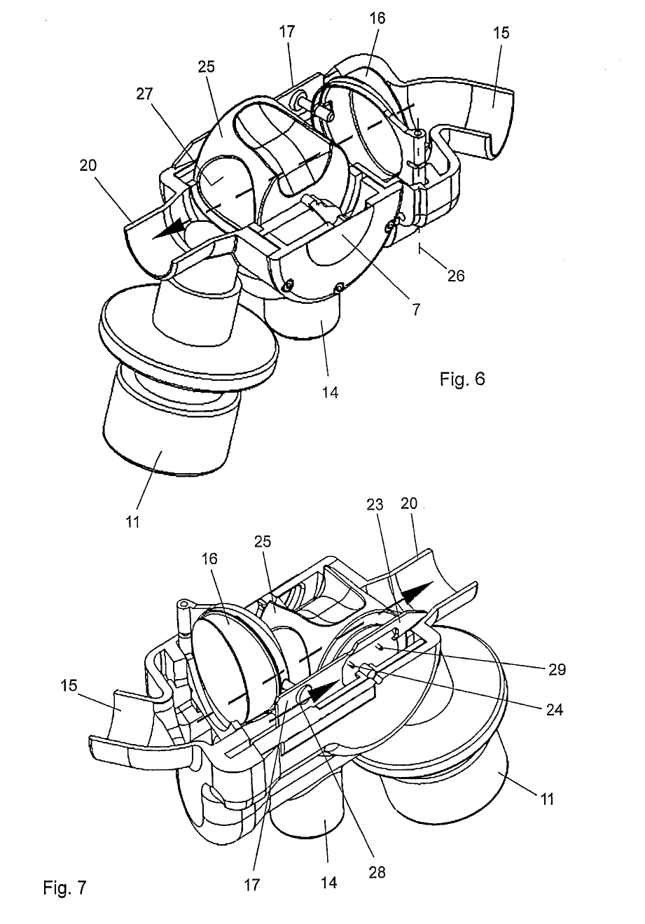

FIG. 6 shows a first view of the valve device during exhalation into the breathing gas reservoir,

FIG. 7 shows a second view of the valve device during exhalation into the breathing gas reservoir,

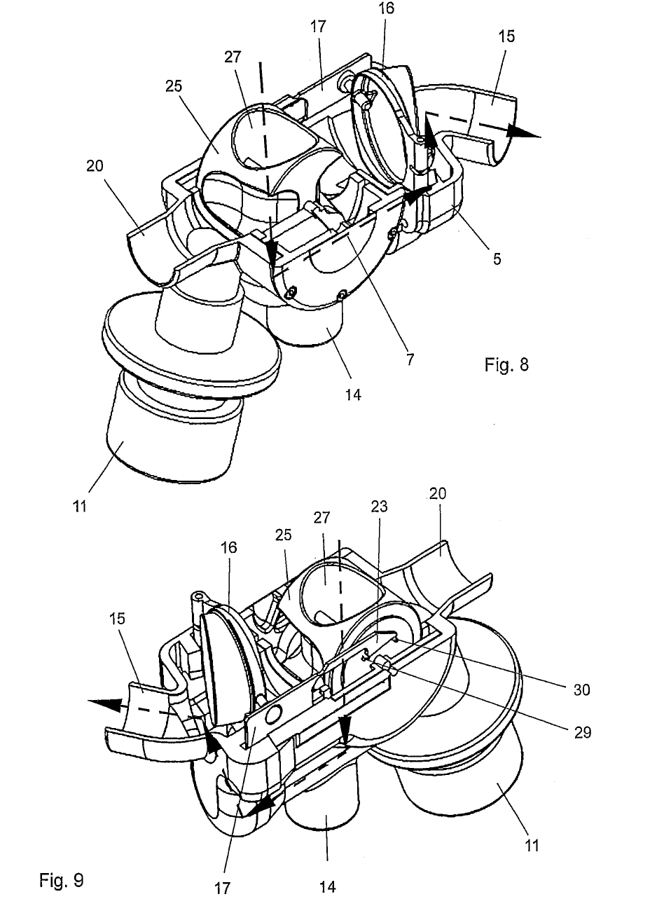

FIG. 8 shows a first view of the valve device during rebreathing from the breathing gas reservoir,

FIG. 9 shows a second view of the valve device during rebreathing from the breathing gas reservoir,

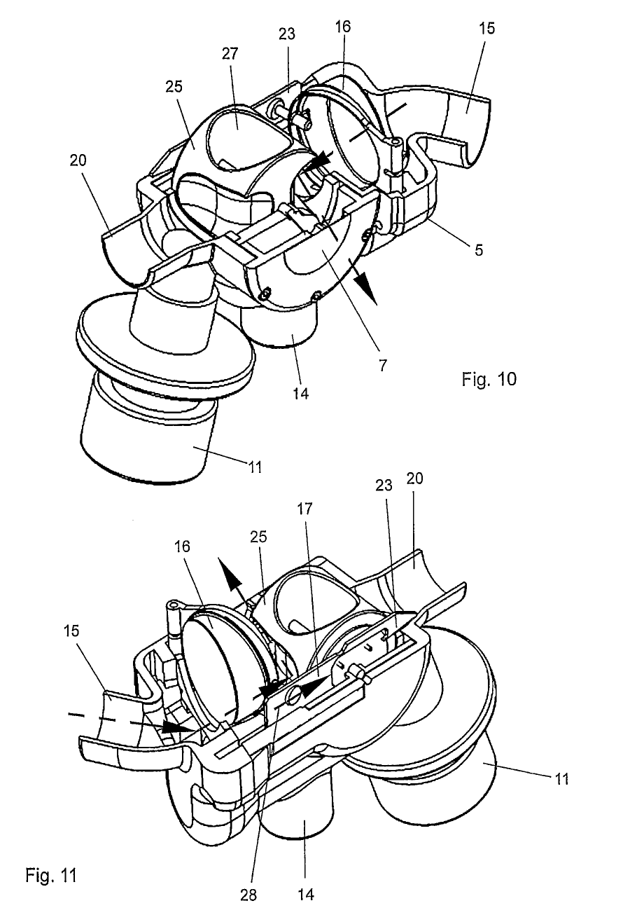

FIG. 10 shows a first view of the valve device during exhalation into the surroundings and

FIG. 11 shows a second view of the valve device during exhalation into the surroundings.

In the diagram illustrating the principle in FIG. 1 a conventional compressed air breathing apparatus, i.e. an SCBA apparatus, is shown that is fitted with a device in accordance with the invention for prolonging the duration of use. The system comprises a storage tank 1 for compressed air which is designed as a compressed air cylinder and to which a pressure regulator 2 is connected. Connected to the pressure regulator 2 via a medium pressure tube 3 is a breathing regulator 4. Instead of the mouthpiece the valve device 5 is connected to the breathing regulator. The valve device 5 has an exhalation/inhalation connection 15 for connecting the mouthpiece 6 and an exhalation opening 7. The valve device 5 is also connected via a connection line 8 to a breathing gas reservoir 9, wherein the connection line 8 can be provided with a soda lime filter 10. A safety valve 11 is also connected to the connection line 8. The breathing gas reservoir 9 is surrounded by a protective mantle 12.

The functioning of the system set out in FIG. 1 is now explained by means of the functional plan in accordance with FIG. 2. On inhalation into the schematically indicated lung 13, fresh air is breathed in from the storage tank 1 via pressure regulator 2, the medium pressure line 3, the breathing regulator 4, the valve device 5 and the mouthpiece 6. During this the valve device 5 is switched in such a way that the air coming from the storage tank 1 flows via the breathing regulator connection 14 of the valve device 5 directly to the inhalation line 16 and via the mouthpiece 6 connected thereto into the lung 13. During the following exhalation the air flows via the mouthpiece 6 into the valve device 5 and, is directed so that it acts on a control valve or valve flap 16 which operates a schematically shown switching element 17. In the position of the switch-over valve 18 shown in FIG. 2, the exhalation flow passes via the connection line 8 and the soda lime filter 10 into the breathing gas reservoir 9. As soon as the exhalation has ended, the resetting of the control valve 16 operates the switching element 17 as a result of which the switch-over valve 18 is moved from the first position shown in FIG. 2 into the second position. In this second position the inhalation connection 15 is now connected via the switch-over valve 18 to the breathing gas reservoir 9 so that air present in the breathing gas reservoir 9 can be rebreathed into the lung 13. During the following exhalation the air from the lung 13 flows via the exhalation connection 15 and the switch-over valve 18 to the exhalation opening 7 and thereby into the surroundings. In doing so the exhaled air flow acts on the control valve 16, wherein on ending of the exhalation the control value 16 interacts with the switching element 17 in such a way that the switch-over valve 18 is moved from the second position back into the first position shown in FIG. 2 so that on subsequent inhalation fresh air can again be inhaled from the storage tank 1.

Shown in FIG. 3 is a preferred embodiment of the valve device 5 together with breathing regulator 4, soda lime container 10 and breathing gas reservoir 9. The valve device 5 has a breathing regulator connection 14 for connecting the breathing regulator 4. The exhalation/inhalation connection for connecting the mouthpiece (not shown) is denoted with 15. The exhalation opening 7 is designed as a shutter valve. In the example of the embodiment shown in FIG. 3, the valve device 5 is connected via a first connection line 22 and via a schematically shown second connection line 21 to the breathing gas reservoir 9. For this purpose the valve device 5 has a connection 19 for the second connection line 21 and a connection 20 for the first connection line 22. The first connection line 22 is provided with a soda lime filter 10 and is arranged in parallel to the second connection line 21. For a better overview, in the following FIGS. 4 to 11 only the valve device 5 is shown, wherein the housing has been partly omitted in order to better illustrate the course of the air flows.

FIGS. 4 and 5 shows the inhalation of fresh air from the storage tank 1 into the lung 13. The fresh air flows via the breathing regulator connection 14 into the valve device 5 and is there guided via a hollow space indicated by the broken line the inhalation/exhalation connection 15. FIG. 5 shows the control valve/control flap 16 which interacts with a switching element in the form of a slider 17. At its free end the slider 17 is provided with a hook-like projection 23 which in the position shown in FIG. 5 engages with a first switching pin 24. The switching pin 24 is arranged on a face surface of the rotary piston 25, the function of which will be described in more detail with the aid of the following figures.

FIGS. 6 and 7 show the exhalation of the air from the lung 13 via the first connection line 20 into the breathing gas reservoir 9. The exhaled air passes via the exhalation/inhalation connection 15 into the valve device 5 and thereby applies pressure to the control valve/valve flap 16, wherein the valve flap 16 is borne in a pivoting manner about the pivot axis 26. The air then flows through the continuous hole 27, formed in the rotary piston 25, and into the first connection line 22 via the connection 20. In FIG. 7 it can be seen that due to the pressure on the valve flap 16 the slider 17 is moved in the direction of the arrow 28. Opening of the exhalation air channel and thus flowing of the exhaled air past the valve flap 16 is only possible after the hook-like projection 23 has cleared the switching pin 29. As soon as the exhalation has ended, the valve flap 16 returns to its original position, for example by means of spring force, as a result of which the slider 17 together with the hook-like projection 23 is pulled back into the position shown in FIG. 9, wherein the hook-like projection 23 during its return movement catches the second switching pin 29 and carries it with it, as a result of which the rotary piston 25 is turned about 90° in order to assume the position shown in FIGS. 8 and 9.

In this position during the subsequent rebreathing, air from the breathing gas reservoir 9 can enter the valve device 5 via the connection 19, which is not shown in FIG. 8, and there flows through the continuous hold 27 of the rotary piston 25 and on to the inhalation/exhalation connection 15 via a hollow space of the housing.

During subsequent exhalation (FIGS. 10 and 11) the air enters the valve device 5 via the inhalation/exhalation connection 15 and presses on the valve plate 16 and is diverted on an oblique surface of the rotary piston 25 to the exhalation opening 7 (shutter valve) and leaves the valve device 5 via this exhalation opening 7. The pressure on the valve plate 16 brings about a displacement of the slider 17 in the direction of the arrow 28, so that after the exhalation the hook-like projection 23 is pulled back during the return movement of the valve plate 16 and thereby engages with and carries along the third control pin 30 on rotary piston 25, as a result of which the rotary piston again turns about 90° and assumes the position shown in FIGS. 4 and 5. In this position the entire cycle can now start from the beginning, and fresh air can be inhaled from the storage tank 1 via the valve devices 5 as shown in FIGS. 4 and 5.

1. Method for prolonging the duration of use of a self-contained compressed air breathing apparatus, which comprises a storage tank for a pressurised gas mixture containing oxygen, a breathing regulator connected to the storage tank, wherein a pressure regulator can optionally be inserted therebetween, and a mouthpiece, comprising the directly consecutive steps:
a) inhalation of the gas mixture from the storage tank,
b) exhalation of the gas mixture into a breathing gas reservoir,
c) inhalation of the gas mixture from the breathing gas reservoir and
d1) exhalation of the gas mixture into the breathing gas reservoir or
d2) exhalation of the gas mixture into the surroundings.

2. Method according to claim 1, wherein a breathing cycle in accordance with step a) and b) and a breathing cycle in accordance with step c) and d2) take place alternately.

3. Method according to claim 1, wherein after a breathing cycle in accordance with step a) and b) at least one breathing cycle in accordance with step c) and d1) and finally a breathing cycle in accordance with step c) and d2) takes place.

4. Method according to claim 3, wherein the number of breathing cycles in accordance with step c) and d1) is selected as a function of at least one environmental factor, more particularly the ambient pressure.

5. Method according to claim 3, wherein a ratio of the breathing cycle in accordance with step a) and b) to the number of breathing cycles in accordance with step c) and d1) of 1:2, 1:3 or 1:4 is selected.

6. Method according to claim 1, wherein during exhalation the mouthpiece is optionally connected either to the breathing gas reservoir or the surroundings by means of a switch-over device, wherein the switch-over device is operated by an inhalation or exhalation air flow.

7. Device for prolonging the duration of use of self-contained compressed air breathing apparatuses, comprising a valve device (5) and a breathing gas reservoir (9), wherein the valve device (5) has at least one exhalation/inhalation connection (15) for connecting to a mouthpiece (6), a breathing regulator connection (14) and an exhalation opening (7) and is connected via at least one connection line (8; 21, 22) with the breathing gas reservoir (9), wherein the valve device (5) interacts with a switch-over device in order to switch, in a breath-dependent manner, the valve device (5) between a first position and a second position, wherein in the first position the exhalation/inhalation connection (15) is connected to the breathing regulator connection (14) for inhalation and with the breathing gas reservoir (9) for exhalation and in the second position the exhalation/inhalation connection (15) is connected to the breathing gas reservoir (9) for inhalation and to the exhalation opening (7) for exhalation.

8. Device according to claim 7, wherein the valve device (5) is connected to the breathing gas reservoir (9) via a first connection line (22) and via a second connection line (21) in parallel thereto, wherein in the first position the exhalation/inhalation connection (15) is connected for inhalation with the breathing regulator connection (14) and for exhalation with the breathing gas reservoir (9) via the first connection line (22) and in the second position the exhalation/inhalation connection (15) is connected for inhalation via the second connection line (21) with the breathing gas reservoir (9) of inhalation and for exhalation with the exhalation opening (7).

9. Device according to claim 7, wherein switch-over device is designed to keep the valve device (5) in the first position for the duration of precisely one breath, to switch it into the second position after the one breath and to keep it in the second position for at least one further breath.

10. Device according to claim 7, wherein the switch-over device is designed to switch over the valve device (5) on each breath.

11. Device according to claim 7, wherein the switch-over device is designed to switch over the valve device (5) at a breathing ratio of 1:2, 1:3 and/or 1:4.

12. Device according to claim 10, wherein the breathing ratio can be adjusted.

13. Device according to claim 7, wherein a sensor for an ambient parameter is provided that interacts with the switch-over device in such a way that the breathing ratio can be adjusted as a function of the ambient parameter.

14. Device according to claim 7, wherein the switch-over device comprises a switching element (17) that can be operated by an exhalation/inhalation air flow.

15. Device according to claim 7, wherein the valve device (5) comprises a rotary piston (25) which is rotatable mounted in a housing and can be operated by the switching element (17).

16. Device according to claim 15, wherein the switch-over device interacts with the rotary piston (25) in such a way that on switching from the first position into the second position the rotary piston (25) is turned about an angle of 90°.

17. Device according to claim 16, wherein the rotary piston (25) has a through hole (27), running perpendicularly to the axis of rotation, in order to connect the exhalation/inhalation connection (15) in the first position via the first connection line (22) to the breathing gas reservoir (9) and in the second position via the second connection line (21) to the breathing gas reservoir (9).

18. Device according to claim 8, wherein a soda lime filter (10) is arranged in the first connection line (22).

19. Device according to claim 8, wherein a safety valve (11) is connected to the first connection line (21).

20. Self-contained compressed air breathing apparatus comprising a storage tank (1) for a compressed gas mixture containing oxygen, a breathing regulator connected to the storage tank (1), wherein a pressure regulator (2) can optionally be inserted therebetween, a mouthpiece (6) and a device according to claim 7, wherein the exhalation/inhalation connection (15) is connected with the mouthpiece and the breathing regulator connection (14) is connected with the breathing regulator (4).

21. Use of a compressed air breathing apparatus according to claim 20 to implement the method.
